(19) United States
(12) Patent Application Publication
(10) Pub. No.: US 2026/0015273 A1
(43) Pub. Date: Jan. 15, 2026

(54) Methods and Systems for Onsite Wastewater Treatment and Reuse

(71) Applicant: Triangle Environmental Health Initiative, LLC, Durham, NC (US)

(72) Inventors: Tate Weston Rogers, Durham, NC (US); Aaron Anthony Forbis-Stokes, Durham, NC (US); Marielle DuToit, Durham, NC (US)

(73) Assignee: Triangle Environmental Health Initiative, LLC, Durham, NC (US)

(21) Appl. No.: 19/264,789

(22) Filed: Jul. 9, 2025

Related U.S. Application Data
(60) Provisional application No. 63/669,464, filed on Jul. 10, 2024.

(51) Int. Cl. C02F 9/00; C02F 103/00

(52) U.S. Cl. CPC C02F 9/00; C02F 2103/005; C02F 2201/008; C02F 2209/40; C02F 2303/14

(57) ABSTRACT

Disclosed are methods, systems and non-transitory computer readable memory for onsite wastewater treatment and reuse. For instance, a wastewater treatment system may include a collection tank configured to receive and store wastewater; a membrane filtration system connected to and receiving wastewater from the collection tank; a sorption unit receiving permeate effluent from the membrane filtration system; and a disinfection unit downstream of the sorption unit.

### CROSS-REFERENCE TO RELATED APPLICATION(S)

This application claims the benefit of U.S. Provisional Application No. 63/669,464, filed Jul. 10, 2024, entitled “Methods and Systems for Onsite Wastewater Treatment and Reuse.”

The contents of each of the above referenced applications are hereby incorporated by reference in their entirety.

### TECHNICAL FIELD

Various aspects of the present disclosure relate generally to methods and systems for wastewater treatment and, more particularly, to methods and systems for onsite wastewater treatment and reuse.

### BACKGROUND

Water scarcity is an increasingly critical issue driven by factors including population growth, urbanization, and climate change. By 2030, it is projected that there will be a 40% global shortfall between water supply and demand. The current standard of using potable water for all household applications is therefore unsustainable. Utilizing alternative water sources for various non-potable uses, both inside and outside buildings, offers a promising solution. For example, replacing potable water with non-potable water in toilet flushing alone can reduce total potable water use by approximately 25% in residential buildings, and up to 75% in commercial buildings. Additional non-potable applications include irrigation, cooling and heating systems, process water, and clothes washing.

Meanwhile, coastal regions experience water, wastewater, and related infrastructural challenges in both urban and rural settings due to sea level rise, land subsidence, and increased flooding events. Many decentralized wastewater treatment systems (e.g., septic systems) in these regions are threatened or already failing. Of the >21 million existing septic systems in the US, nearly half are estimated to be malfunctioning. Private water wells are increasingly limited by saltwater intrusion and contamination from failing septic systems, and 1.2 to 14 million people and >50% of infrastructures in major cities such as New York, Baltimore, and Norfolk are exposed to subsidence rates between 1 and 2 mm per year, and the highest subsidence rates impacting the largest percent of land were found in coastal VA. See A. Littlehales, “Coastal Virginia is sinking about 2 millimeters every year. Could treated wastewater slow it down?,” 13 News Now (WVEC), Norfolk, VA, Apr. 10, 2024. Accessed: Jul. 22, 2024. [Online]. Available: https://www.13newsnow.com/article/tech/science/environment/coastal-virginia-land-sinking-treated-wastewater/291-0ace6b31-7180-4187-803a-312e3acad83a.

The present disclosure is directed to overcoming one or more of these above-referenced challenges. In some applications, the methods and systems can be used in urban commercial buildings to treat greywater and reuse it onsite for non-potable purposes, offering significant water usage savings and increasing the resiliency and capacity of municipal water and wastewater infrastructure. In some applications, the methods and systems can be used in residential (from urban to off-grid) homes to treat greywater and reuse it onsite for non-potable purposes to greatly minimize the burden on private wells and existing wastewater systems. In some applications, the methods and systems can be used in non-municipal buildings or homes to treat combined wastewater (e.g., septic tank effluent) to a non-potable standard that is safe for non-potable reuse or environmental discharge, particularly in coastal regions. In this application, the methods and systems can be implemented such that they are flood-proofed and used as a retrofit for already-failing systems or for new installations in areas soils that are already inundated.

### SUMMARY OF THE DISCLOSURE

According to certain aspects of the disclosure, systems, methods, and computer readable memory are disclosed for onsite wastewater treatment and reuse.

In some cases, a wastewater treatment system may include: a collection tank configured to receive and store wastewater; a membrane filtration system connected to and receiving wastewater from the collection tank; a sorption unit receiving permeate effluent from the membrane filtration system; and a disinfection unit downstream of the sorption unit.

In some cases, a method for treating wastewater may include receiving and storing wastewater in a collection tank; passing the wastewater from the collection tank to a membrane filtration system; filtering the wastewater using the membrane filtration system to produce a permeate effluent; passing the permeate effluent to a sorption unit; treating the permeate effluent in the sorption unit; and disinfecting the treated effluent from the sorption unit in a disinfection unit.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts a system for onsite wastewater treatment and reuse.

FIG. 2 depicts a schematic showing the ability of the waste treatment system to be elevated above ground level for flood protection.

FIG. 3 depicts a flowchart of an exemplary method for onsite wastewater treatment and reuse.

FIG. 4 depicts an example system that may execute techniques presented herein.

### DETAILED DESCRIPTION

The benefits of a comprehensive wastewater treatment and reuse system extend beyond water conservation as well. Treating and reusing greywater, blackwater, and septic tank effluent onsite reduces the burden on municipal wastewater infrastructure and decreases the environmental impact of wastewater discharge. This approach also aligns with progressing regulatory and environmental standards aimed at promoting water reuse and sustainability. Further, the ability to treat mixed greywater and blackwater streams provides flexibility for installation in various contexts, from urban high-rise buildings to rural properties with septic systems. By addressing the full spectrum of domestic wastewater, advanced treatment and reuse systems offer a significant step forward in sustainable water management practices.

However, existing technical approaches present limitations to widespread adoption at both residential and commercial scales, particularly due to space requirements and operational complexity. Nearly all of these systems rely on biological processes, which necessitate large footprints to provide sufficient reaction times. This loss of space can be a significant issue in some applications, especially commercial buildings in high-cost real estate markets. Additionally, system installation can be incredibly disruptive in both residential and commercial settings. Advancements in biological treatment systems also demand substantial operational upkeep, making them impractical for residential use. Further, these systems face challenges in specific market applications, such as ineffective operation in areas prone to power outages and flooding events.

The purpose of the present invention is to effectively address these limitations by providing a solution with a compact footprint that can adapt to local conditions—such as fitting into a parking space in the basement of a commercial building, into a utility close in a private residence, or elevated above flood levels in coastal regions. The system of the present invention also features resilience to varying feed characteristics, as well as high-throughput disinfection that does not require additional consumable materials and, in applications where desirable, can provide a chlorine residual in the product water, enabling longer storage before reuse. These features ensure that the presented technology not only meets current market needs but also enhances the safety, sustainability, and reliability of onsite wastewater treatment and reuse. Implementing our technology to reuse water for toilet flushing and laundry could reduce household potable water consumption by about 40%, providing annual savings of approximately 73,000 liters for a family of four. This significant reduction highlights the importance of adopting non-potable water solutions to address future water shortages. Such a system of the present invention is thus appropriate for a wide range of applications, including private residences, multi-tenant residential complexes, and commercial facilities in urban or rural settings.

The present disclosure provides a non-biological method for the rapid, fully automated treatment of wastewater to non-potable reuse quality for onsite reuse or safe discharge. The proposed system is a multi-stage treatment process that provides a final effluent that meets non-potable reuse requirements, while maintaining lower operating costs and improved energy efficiencies compared to other existing treatment systems on the market.

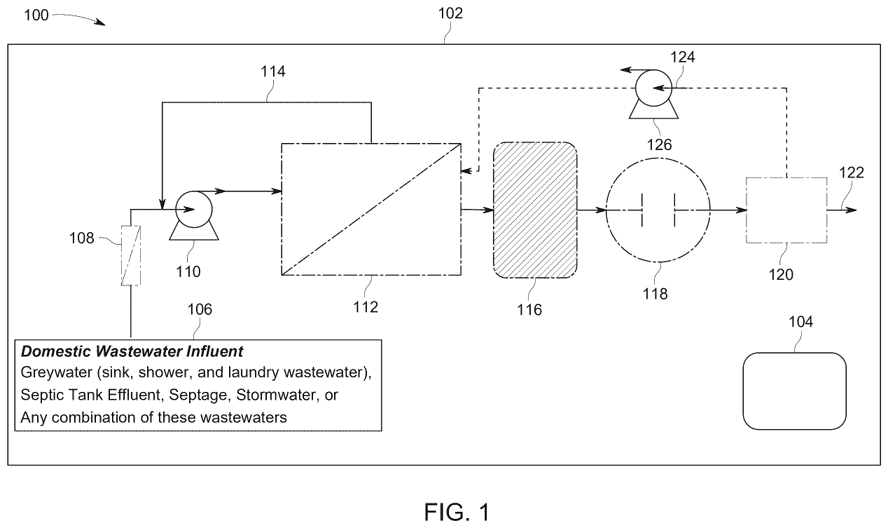

In an aspect, the presented non-biological wastewater treatment system comprises: a collection tank configured to receive and store wastewater (e.g., any one or combinations of stormwater, greywater, blackwater, and/or septic tank effluent); a membrane filtration system connected to and receiving wastewater from the collection tank; a sorption unit receiving permeate effluent from the membrane filtration system; a disinfection unit downstream of the sorption unit; and a control system for process automation (FIG. 1). Optionally, a pre-filter may be used in advance of membrane filtration to remove debris or large suspended solids from influent water. Optionally, final treated effluent from the disinfection unit may be stored in a treated water storage tank, wherein the storage tank is designed to maintain treated water quality.

In some embodiments, the non-biological wastewater treatment system may be paired with biological treatment systems to improve the effluent quality of biologically treated wastewater.

In a process, the method for non-biological wastewater treatment includes pumping wastewater which includes greywater (sink, shower, laundry), blackwater (toilet and kitchen), septic tank effluent, septage, stormwater, or a combination thereof into the wastewater collection tank; passing the wastewater influent into the membrane filtration system; passing the effluent from the membrane filtration system into the sorption unit; passing the effluent from the sorption unit into the disinfection unit; and either passing the final treated effluent from the sorption unit directly to onsite applications for immediate reuse, holding the final treated effluent in a treated water storage tank, or safely releasing into the environment whatever volume is not required for reuse.

In a process, wastewater influent is optionally pre-filtered before pumping into the membrane filtration system. In a process with pre-filtration, filters with sieve sizes ranging from 50 μm to 3.175 mm may be used.

In an aspect, the method further comprises utilizing a ceramic membrane in the membrane filtration system to remove suspended solids and other non-dissolved contaminants. In some embodiments, the ceramic membrane comprises a microfiltration or ultrafiltration or nanofiltration membrane. In some embodiments, the ceramic membrane constitutes a tubular membrane. In some embodiments, the membrane filtration system may use optional crossflow. In some embodiments, the membrane filtration system utilizing crossflow may operate at crossflow velocities of 0.5-1 m/s, 1-2 m/s, 2-3 m/s, 3-4 m/s, 4-5 m/s, or 5-6 m/s. In some embodiments, the membrane filtration system may produce permeate flux rates of 50-250 L/m²/h, 250-500 L/m²/h, 500-750 L/m²/h, 750-1000 L/m²/h, 1000-1250 L/m²/h, or 1250-1550 L/m²/h.

In an aspect, the sorption system utilizes granular activated carbon to capture dissolved organic compounds and trace contaminants. In some embodiments, the sorption system utilizes granular activated carbon with sieve sizes ranging from 0.045 mm to 4.75 mm.

In some embodiments, the disinfection system comprises chlorine dosing, electro-chlorination, UV irradiation, ozonation, or a combination thereof, to eliminate pathogenic microorganisms and ensure effluent safety. In some embodiments, disinfection units utilizing electro-chlorination may contain optional custom-made electrodes for improved electro-chlorination performance.

In some embodiments, the membrane filtration system may utilize optional backwash purging with water or air or oxygen or a combination thereof to remove adhered foulants from the membrane surface and interior. In some embodiments, the fully treated effluent in the treated water tank may optionally be used as a water source for membrane back washing during cleaning cycles.

In another aspect, the non-biological wastewater treatment system may utilize an optional automated cleaning system that applies acidic treatment, caustic treatment, bleach treatment, flushing of hot water >100° F., or a combination thereof for advanced cleaning and foulant removal.

In another aspect, the wastewater treatment system may be operated at 7 kWh/day.

As stated, the system was conceptualized to be able to treat a wide range of source waters while also providing a high-quality effluent that meets reuse standards. Target standards include National Sanitation Foundation (NSF) 350, International Association of Plumbing & Mechanical Officials (IAPMO) Z1324, and other emerging guidelines. The system has been tested with multiple types of wastewater and demonstrated the capacity to meet these requirements.

Table 1 depicts results from testing with different wastewater sources. The values provided represent the interquartile range during the testing period.

TABLE 1

| | Greywater | | Septic Tank Effluent | |
|---|---|---|---|---|
| Parameter | Feed | Effluent | Feed | Effluent |
| TSS (mg/L) | 100-390 | 0 | 100-200 | 0 |
| COD (mg/L) | 350-2,000 | 0-30 | 220-360 | 2-20 |
| Turbidity (NTU) | — | — | 100-200 | 0.5-1.5 |
| E. coli (MPN) | 10\hat{ }7 | Non-detect | — | — |
| Free chlorine | — | 0.8-2.2 | — | 0.9-3.0 |
| (mg/l) | | | | |

Thus, methods and systems of the present disclosure may be improvements to onsite wastewater treatment and reuse.

### System

FIG. 1 depicts an environment 100 for a wastewater treatment system 102 for onsite wastewater treatment and reuse.

In some aspects, the wastewater treatment system 102 may include multiple components configured to process various types of wastewater for non-potable applications. The system 102 may comprise a collection tank for receiving and storing wastewater from different sources. In some cases, the wastewater may include greywater, septic tank effluent, septage, or combinations thereof.

The system 102 may further include a membrane filtration unit connected to the collection tank. In some implementations, the membrane filtration unit may receive wastewater from the collection tank and remove suspended solids and other non-dissolved contaminants. A sorption unit may be positioned downstream of the membrane filtration unit. In certain aspects, the sorption unit may receive permeate effluent from the membrane filtration unit and capture dissolved organic compounds and trace contaminants.

Additionally, the system 102 may incorporate a disinfection unit downstream of the sorption unit. The disinfection unit may be configured to eliminate pathogenic microorganisms and ensure effluent safety. In some cases, a control system may be included to provide process automation for the wastewater treatment system.

The system 102 may offer several potential benefits. For example, the system 102 may allow for onsite treatment and reuse of wastewater, which may reduce demand on municipal water supplies and wastewater infrastructure. They system may be used to allow onsite treatment in regions facing water inundation. The compact design of the system may enable installation in various settings with limited space. Additionally, the non-biological treatment approach may provide resilience to varying feed characteristics and high-throughput disinfection without requiring additional consumable materials.

The system 102 may be configured to process various types of domestic wastewater influent 106, which may include greywater, septic tank effluent, septage, or combinations thereof. In some aspects, the system 102 may comprise several components arranged in a specific order to treat the wastewater.

The system 102 may include a collection tank, which in some implementations may be represented by the domestic wastewater influent 106 source. This collection tank may be configured to receive and store wastewater from different sources within a residential or commercial setting.

In some cases, the wastewater from the collection tank may first pass through an optional pre-filter 108. The pre-filter 108 may remove larger debris from the wastewater before further processing. A pump 110 may then transfer the wastewater to subsequent treatment stages.

The system 102 may include a membrane filtration system, which in this illustration may be represented by the ultrafiltration unit 112. The membrane filtration system may be connected to and receive wastewater from the collection tank or pre-filter. In some implementations, the ultrafiltration unit 112 may utilize ceramic membranes or other suitable filtration media to remove suspended solids and other non-dissolved contaminants from the wastewater.

In some aspects, the system 102 may include a recirculation line 114 that connects the downstream side of the ultrafiltration unit 112 to the upstream side of the pump 110. This recirculation line 114 may allow for the partial recirculation of feed water back to the inlet of the ultrafiltration unit 112. The recirculation line 114 may serve multiple purposes within the wastewater treatment system. In some implementations, it may help maintain a consistent flow rate through the ultrafiltration unit 112, which may improve filtration efficiency and reduce membrane fouling. The recirculation line 114 may also allow for the adjustment of the concentration factor in the ultrafiltration process, potentially optimizing the removal of contaminants. In certain cases, the recirculation line 114 may be equipped with a flow control valve or a dedicated recirculation pump to regulate the amount of water being recirculated. The use of a recirculation line 114 may contribute to the overall flexibility and performance of the wastewater treatment system, allowing for fine-tuning of the treatment process based on influent characteristics and desired effluent quality.

Downstream of the membrane filtration system, the system 102 may incorporate a sorption unit. In the illustrated example, this may be represented by the granular activated carbon unit 116. The sorption unit may receive permeate effluent from the membrane filtration system. In some aspects, the granular activated carbon unit 116 may capture dissolved organic compounds and trace contaminants that pass through the membrane filtration stage.

Following the sorption unit, the system 102 may include a disinfection unit 118 positioned downstream. The disinfection unit 118 may be configured to eliminate pathogenic microorganisms and ensure the safety of the treated effluent. In some implementations, the disinfection unit 118 may utilize methods such as electro-chlorination, UV irradiation, ozonation, or combinations thereof.

In some cases, the system 102 may optionally include an effluent tank 120 positioned downstream of the disinfection unit 118. This tank may store the treated water before it is released as non-potable reuse water 122.

In some aspects, the system 102 may include a backwash line 126 connected to a backwash pump 124. The backwash line 126 may extend from the downstream side of the effluent tank 120 to the upstream side of the ultrafiltration unit 112. This configuration may allow for periodic backwashing of the ultrafiltration unit 112 using treated water from the effluent tank 120. The backwash process may help remove accumulated foulants from the membrane surface and interior, potentially improving the performance and extending the operational life of the ultrafiltration unit 112. In some implementations, the backwash pump 124 may be controlled by the system's automation to initiate backwash cycles based on various parameters such as operating time, pressure differential across the membrane, or permeate flux decline. The backwash line 126 may be equipped with appropriate valves and flow control devices to manage the backwash process effectively.

In some aspects, the backwash pump can be replaced by connecting to pressurized municipal water sources in connection to an automated valve and backflow preventions.

In some aspects, the backwash approach described may be augmented by chlorine and/or caustic solutions to provide enhanced backwashing and fouling prevention.

The wastewater treatment system 102 may also incorporate a control system 104. This control system 104 may be configured to manage and automate the operation of various components and processes within the system 102, ensuring efficient and effective treatment of the wastewater.

In some aspects, the wastewater treatment process may begin with receiving and storing wastewater in a collection tank. The collection tank may be configured to accommodate various types of wastewater, including greywater, blackwater, septic tank effluent, septage, or combinations thereof. The collection tank may serve as a buffer to manage fluctuations in wastewater inflow and provide a consistent feed to the subsequent treatment stages.

From the collection tank, the wastewater may be passed to a membrane filtration system. In some implementations, this transfer may be facilitated by a pump, such as the pump 110 shown in FIG. 1. The membrane filtration system, which may be represented by the ultrafiltration unit 112 in FIG. 1, may be designed to remove suspended solids and other non-dissolved contaminants from the wastewater.

The membrane filtration system may utilize various types of membranes, including but not limited to ceramic membranes. In some cases, the membrane filtration system may employ microfiltration, ultrafiltration, or nanofiltration membranes, depending on the specific treatment requirements. The filtration process may produce a permeate effluent, which is the filtered water that passes through the membrane.

Following the membrane filtration stage, the permeate effluent may be passed to a sorption unit. In the system illustrated in FIG. 1, this sorption unit may be represented by the granular activated carbon unit 116. The sorption unit may be configured to receive the permeate effluent directly from the membrane filtration system.

In the sorption unit, the permeate effluent may undergo treatment to remove dissolved organic compounds and trace contaminants that may have passed through the membrane filtration stage. The sorption process may involve the use of various media, with granular activated carbon being a common choice due to its high adsorption capacity. In some implementations, the granular activated carbon may have sieve sizes ranging from 0.045 mm to 4.75 mm, allowing for effective capture of a wide range of contaminants.

The treatment in the sorption unit may involve multiple mechanisms, including physical adsorption and chemical interactions between the contaminants and the sorption media. This stage of the treatment process may be particularly effective in removing organic compounds, chlorine, and other trace contaminants that can affect the taste, odor, and overall quality of the treated water.

By incorporating these stages-collection, membrane filtration, and sorption-the wastewater treatment system may effectively remove a broad spectrum of contaminants, preparing the water for final disinfection and potential reuse in non-potable applications. This multi-barrier approach may help ensure consistent and reliable treatment performance across varying wastewater compositions and qualities.

After treatment in the sorption unit, the effluent may be passed to a disinfection unit for final treatment. In the system illustrated in FIG. 1, this disinfection unit may be represented by the disinfection unit 118. The disinfection unit may be configured to eliminate pathogenic microorganisms and ensure the safety of the treated effluent for non-potable reuse applications.

In some implementations, the disinfection process may utilize various methods, including electro-chlorination, UV irradiation, ozonation, or combinations thereof. Each of these disinfection methods may offer specific advantages depending on the application and water quality requirements.

Electro-chlorination may involve the generation of chlorine-based disinfectants through an electrochemical process. This method may provide effective disinfection while also producing a residual disinfectant that can help maintain water quality during storage or distribution. In some cases, the electro-chlorination units may incorporate custom-made electrodes to enhance performance and efficiency.

UV irradiation may use ultraviolet light to inactivate microorganisms by disrupting their DNA. This method may be particularly effective against chlorine-resistant pathogens and may not introduce any chemical residuals into the treated water.

Ozonation may involve the use of ozone gas as a powerful oxidizing agent to destroy microorganisms and break down organic contaminants. This method may provide rapid disinfection and can also help improve water taste and odor.

In some aspects, the disinfection unit may employ a combination of these methods to achieve comprehensive pathogen inactivation and ensure robust treatment performance across varying water qualities.

Following disinfection, the treated effluent may be suitable for various non-potable reuse applications. However, in some implementations, the system may include an additional step of storing the disinfected effluent in a treated water tank. As shown in FIG. 1, this may be represented by the optional effluent tank 120 positioned downstream of the disinfection unit 118. In other implementations, the disinfected effluent may safely flow directly into the environment where reuse is not desired or necessary.

The treated water tank may serve several purposes. It may act as a buffer to manage variations in water demand and supply, ensuring a consistent availability of treated water for reuse applications. Additionally, in cases where chlorine-based disinfection is used, the tank may be designed to maintain treated water quality by preserving the chlorine residual, thus preventing recontamination during storage.

In some aspects, the treated water stored in this tank may also serve as a source for backwashing operations during cleaning cycles of the membrane filtration system. This approach may help optimize water use within the treatment system and reduce the need for external water sources for maintenance operations.

The inclusion of a treated water storage tank may enhance the flexibility and reliability of the wastewater treatment system, allowing for more efficient water management and reuse strategies in various residential and commercial applications.

In some aspects, the wastewater treatment system may include additional optional components to enhance its performance and flexibility. For example, a treated water tank may be optionally positioned downstream of the disinfection unit 118 for the storage of treated water. This tank, which may be represented by the optional effluent tank 120 in FIG. 1, may serve multiple purposes. It may provide a buffer to manage fluctuations in treated water demand and supply, ensuring a consistent availability of non-potable reuse water 122. Additionally, the tank may be designed to maintain treated water quality and prevent recontamination, particularly when used in conjunction with a chlorination method such as electro-chlorination.

The membrane filtration system, represented by the ultrafiltration unit 112 in FIG. 1, may be paired with optional pre-filters in advance of membrane filtration. These pre-filters, which may be represented by the pre-filter 108 in FIG. 1, may be used to remove debris or large suspended solids from feed water. This pre-filtration step may help protect the membrane filtration system from excessive fouling and potentially extend its operational lifespan.

In some implementations, the wastewater treatment system 102 may be designed with the capability to be paired with biological treatment systems. This integration may allow for improved effluent quality of biologically treated wastewater. The combination of biological and non-biological treatment processes may provide a more comprehensive approach to wastewater treatment, potentially expanding the range of applications for the system.

The treated water tank positioned downstream from the disinfection unit 118, such as the optional effluent tank 120, may be specifically designed to maintain treated water quality. In cases where a chlorination method such as electro-chlorination is used, the tank may be configured to preserve the chlorine residual in the treated water. This design consideration may help prevent recontamination during storage, ensuring that the treated water remains safe for non-potable reuse applications.

In terms of operational efficiency, the wastewater treatment system 102 may be designed to operate at low energy consumption levels. In some implementations, the system may be operated at approximately 7 kWh/day. This energy-efficient operation may contribute to the overall sustainability and cost-effectiveness of the wastewater treatment and reuse process.

The incorporation of these optional components and system integration capabilities, along with the focus on operational efficiency, may enhance the versatility and performance of the wastewater treatment system 102. These features may allow the system to adapt to various wastewater sources and treatment requirements while maintaining energy efficiency and treated water quality.

In some aspects, the membrane filtration system may utilize ceramic membranes to remove suspended solids and other non-dissolved contaminants from the wastewater. The ceramic membrane may comprise a microfiltration, ultrafiltration, or nanofiltration membrane, depending on the specific treatment requirements and desired effluent quality. Microfiltration membranes typically have pore sizes ranging from 0.1 to 10 micrometers, ultrafiltration membranes have pore sizes ranging from 0.01 to 0.1 micrometers, and nanofiltration membranes have even smaller pore sizes, typically less than 0.001 micrometers.

The choice of membrane type may depend on factors such as the characteristics of the influent wastewater, the target contaminants to be removed, and the intended use of the treated water. For example, microfiltration membranes may be suitable for removing larger particles and some bacteria, while ultrafiltration membranes may be more effective at removing smaller particles, viruses, and some dissolved organic compounds. Nanofiltration membranes may provide even finer filtration, potentially removing some dissolved salts and smaller organic molecules.

In some implementations, the ceramic membrane may constitute a tubular membrane. Tubular membranes may offer advantages such as high surface area to volume ratio, ease of cleaning, and resistance to fouling. The tubular configuration may also allow for effective crossflow operation, which can help maintain membrane performance over time.

To enhance the performance and longevity of the membrane filtration system, pre-filtering the wastewater before passing it to the membrane filtration system may be employed. This pre-filtration step may help remove debris or large suspended solids from the feed water, protecting the more sensitive membrane components from excessive fouling or damage.

The pre-filtration system may utilize various types of filters, such as screen filters, disc filters, or media filters. The choice of pre-filter may depend on the characteristics of the influent wastewater and the specific requirements of the downstream membrane system. In some cases, multiple stages of pre-filtration may be employed, with progressively finer filtration at each stage.

The pre-filtration process may help extend the operational life of the membrane filtration system, reduce the frequency of membrane cleaning or replacement, and improve overall system efficiency. By removing larger particles and debris, pre-filtration may also help maintain consistent flow rates through the membrane system, potentially enhancing the quality and quantity of treated water produced.

In some aspects, the pre-filtration system may be designed to be easily maintainable, with features such as automatic backwashing or easy manual cleaning procedures. This may help ensure consistent performance of both the pre-filtration and membrane filtration stages over time, contributing to the overall reliability and effectiveness of the wastewater treatment system.

### Flood Protection

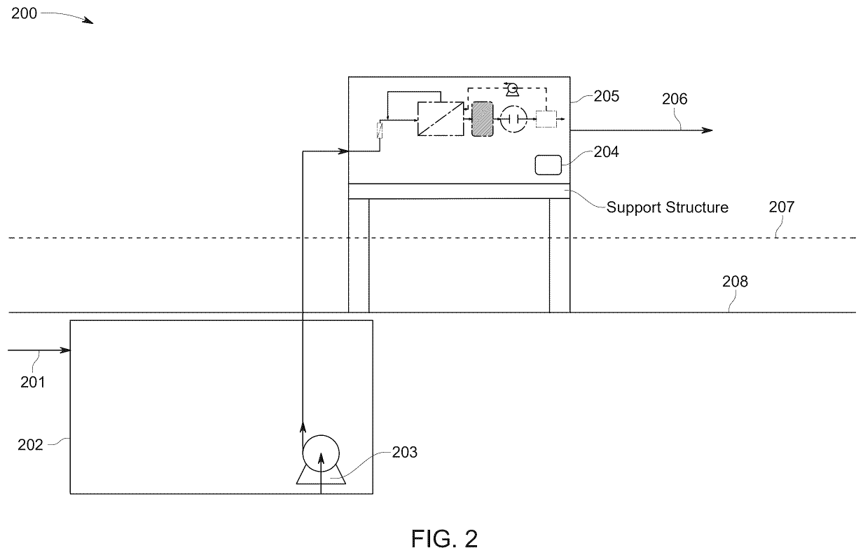

FIG. 2 depicts a schematic showing the ability of the waste treatment system to be elevated above ground level for flood protection.

The wastewater treatment system may provide a non-biological method for treating various types of wastewater to a quality suitable for non-potable reuse applications or safe discharge. In some cases, the system may be designed with a compact footprint to allow installation in space-constrained environments such as parking spaces in commercial building basements or utility closets in private residences.

The wastewater treatment system may comprise multiple components arranged in a specific treatment sequence. A collection tank may be configured to receive and store wastewater from different sources. The collection tank may accommodate greywater, blackwater, septic tank effluent, septage, or combinations thereof.

From the collection tank, wastewater may pass to a membrane filtration system. The membrane filtration system may be connected to and receive wastewater directly from the collection tank. The membrane filtration process may remove suspended solids and other non-dissolved contaminants from the wastewater.

Downstream of the membrane filtration system, a sorption unit may be positioned to receive the permeate effluent. The sorption unit may capture dissolved organic compounds and trace contaminants that pass through the membrane filtration stage.

Following the sorption unit, a disinfection unit may be incorporated to provide final treatment. The disinfection unit may be configured to eliminate pathogenic microorganisms and ensure the safety of the treated effluent for non-potable reuse applications.

In some cases, the wastewater treatment system may be specifically designed to treat septic tank effluent. The multi-stage treatment process may produce effluent of sufficient quality to enable alternative discharge methods without requiring a traditional soil absorption field (i.e., drainfield). This capability may provide flexibility for wastewater management in areas with challenging soil conditions or space limitations.

FIG. 2 depicts a treatment system diagram 200 illustrating an elevated configuration of a wastewater treatment system for flood protection. The treatment system diagram 200 may include a wastewater influent 201 that flows into a wastewater collection tank 202. The wastewater collection tank 202 may contain a pump 203 for transferring wastewater to subsequent treatment stages.

In some cases, a control system 204 may be positioned above a base flood elevation 207. The control system 204 may connect to a treatment system 205 (e.g., wastewater treatment system 102. The treatment system 205 may process the wastewater and produce a treated water output 206 suitable for non-potable reuse or discharge.

The treatment system 205 may be supported by a structure that elevates the treatment system 205 above the base flood elevation 207. The base flood elevation 207 may be indicated by a line across the treatment system diagram 200, positioned between a ground level 208 and the treatment system 205.

The ground level 208 may be shown at the bottom of the treatment system diagram 200, with the wastewater collection tank 202 positioned below the ground level 208. The elevation of the treatment system 205 and control system 204 above the base flood elevation 207 may allow for operation of the wastewater treatment system in flood prone or high water table areas.

In some implementations, the treatment system 205 may be contained within an above-ground enclosure. The above-ground enclosure may be configured to facilitate relocation of the treatment system 205 to an alternative site. This configuration may provide flexibility in system placement and allow for adaptation to changing environmental conditions or site requirements.

The elevated configuration of the treatment system 205 may offer several potential benefits. By positioning the critical components of the wastewater treatment system above the base flood elevation 207, the system may continue to function during flood events. This elevated design may help protect sensitive equipment from water damage and ensure continuity of wastewater treatment operations in flood-prone areas.

Additionally, the elevated configuration may allow for easier access to system components for maintenance and repairs, as the treatment system 205 may be positioned at a more convenient working height. This arrangement may also facilitate visual inspection of the system and early detection of potential issues.

In some cases, the wastewater collection tank 202 may remain below the ground level 208 to allow for gravity-fed inflow of wastewater. The pump 203 within the wastewater collection tank 202 may then transfer the wastewater to the elevated treatment system 205 for processing.

The treated water output 206 from the elevated treatment system 205 may be directed to appropriate discharge points or reuse applications, depending on local regulations and intended use of the treated water. The elevation of the treatment system 205 may also provide additional head pressure for the treated water output 206, potentially reducing or eliminating the need for additional pumping in some applications.

The wastewater treatment system may integrate multiple components to achieve effective wastewater treatment across varying influent compositions. In some cases, the treatment process may begin with receiving and storing wastewater in the wastewater collection tank 202. The wastewater collection tank 202 may accommodate greywater, septic tank effluent, septage, or combinations thereof.

From the wastewater collection tank 202, the pump 203 may transfer wastewater to subsequent treatment stages. In some implementations, the treatment system 205 may include a pre-filter positioned before a membrane filtration system. The pre-filter may remove debris or large suspended solids from the feed water, potentially extending the operational life of the membrane filtration system.

The membrane filtration system may utilize a ceramic membrane to remove suspended solids and other non-dissolved contaminants. In some cases, the ceramic membrane may comprise a microfiltration, ultrafiltration, or nanofiltration membrane. The ceramic membrane may constitute a tubular membrane, which may offer advantages such as high surface area to volume ratio and resistance to fouling.

In some aspects, the membrane filtration system may utilize optional crossflow. The membrane filtration system with crossflow may operate at crossflow velocities of 0.5-6 m/s. This configuration may help maintain membrane performance over time. The membrane filtration system may produce permeate flux rates of up to 1550 L/m²/h.

The treatment system 205 may include a recirculation line connecting the downstream side of the membrane filtration system to the upstream side of the pump 203. This recirculation may allow for adjustment of the concentration factor in the membrane filtration process, potentially optimizing contaminant removal.

Downstream of the membrane filtration system, a sorption unit may receive the permeate effluent. The sorption system may utilize granular activated carbon to capture dissolved organic compounds and trace contaminants. In some implementations, the sorption unit may use granular activated carbon with sieve sizes ranging from 0.045 mm to 4.75 mm.

Following the sorption unit, the treatment system 205 may incorporate a disinfection unit. The disinfection unit may comprise electro-chlorination, UV irradiation, ozonation, or a combination thereof to eliminate pathogenic microorganisms. In some embodiments, the disinfection process may create a residual disinfection chemical such as chlorine. The disinfection unit may contain custom-made electrodes for improved electro-chlorination performance.

In some cases, a treated water tank may be optionally positioned downstream of the disinfection unit for storage of the treated water output 206. The treated water tank may be designed to maintain treated water quality and prevent recontamination.

The treatment system 205 may include a backwash line connected to a backwash pump, extending from the downstream side of the treated water output 206 to the upstream side of the membrane filtration system. This configuration may allow for periodic backwashing of the membrane filtration system using treated water. The membrane filtration system may utilize optional backwash purging with water, air, oxygen, or a combination thereof to remove adhered foulants from the membrane surface and interior.

In some configurations, the backwash pump and stored treated water can be replaced by connecting to pressurized municipal water sources in connection to an automated valve and backflow preventions.

In some implementations, the wastewater treatment system may utilize an optional cleaning system. This cleaning system may apply acidic treatment, caustic treatment, bleach treatment,, flushing of hot water above 100° F., or a combination thereof for advanced cleaning and foulant removal to restore performance.

The control system 204 may manage and automate the operation of various components and processes within the treatment system 205. In some aspects, the wastewater treatment system may be operated at 7 kWh/day, contributing to energy-efficient operation.

By integrating these components and processes, the wastewater treatment system may adapt to different wastewater compositions while maintaining consistent treatment performance. The multi-barrier approach of membrane filtration, sorption, and disinfection may provide robust contaminant removal across varying influent characteristics.

### Commercial Process

In some cases, the systems and methods of the present disclosure may be used for a treatment system process diagram for commercial wastewater treatment and reuse.

The system may comprise several interconnected components designed to process and treat wastewater for non-potable reuse applications.

In some aspects, the system may begin with a wastewater feed tank located in an off-skid section. A feed pump may draw water from this tank and send it to an on-skid section for treatment. The on-skid section may include various components arranged to progressively treat the wastewater.

The wastewater may first encounter a manual valve that may serve as a cleaning port. The flow may then pass through a check valve before entering a series of manual valves that may control the flow path through the system.

Central to the treatment process may be at least one first membrane module, which receive flow from the control value and manual valves. In some implementations, the at least one first membrane module may be a ceramic ultrafiltration membrane module. The ceramic membrane may comprise a microfiltration, ultrafiltration, or nanofiltration membrane, depending on the specific treatment requirements. In some cases, the ceramic membrane may constitute a tubular membrane, which may offer advantages such as high surface area to volume ratio and resistance to fouling.

The membrane filtration system may utilize a ceramic membrane to remove suspended solids and other non-dissolved contaminants from the wastewater. This filtration step may produce a permeate effluent, which may then be directed to subsequent treatment stages.

Downstream of the at least one first membrane module, a second filtration module may receive flow via check valves from the at least one first membrane module. The second filtration module may represent a granular activated carbon bed. This sorption system may utilize granular activated carbon to capture dissolved organic compounds and trace contaminants. The granular activated carbon may have sieve sizes ranging from 0.045 mm to 4.75 mm, allowing for effective removal of a wide range of contaminants.

The system may also include at least one (e.g., two) electro-chlorination units, each with a 24 VDC input, downstream of the second filtration module. These units may be preceded by check valves to prevent backflow. The electro-chlorination units may serve as part of the disinfection system, which may comprise electro-chlorination, UV irradiation, ozonation, or a combination thereof to eliminate pathogenic microorganisms. In some embodiments, the electro-chlorination process may create a residual disinfection chemical such as chlorine.

A backwash pump may be connected between effluent tank and the at least one first membrane module via an automated valve, allowing for cleaning of the membrane modules when necessary. This backwash capability may help maintain the performance of the membrane filtration system over time.

The treated water may be collected in an effluent tank. This tank may serve to store the treated water before it is used for non-potable reuse applications.

Throughout the system, there may be several sample and cleaning ports that may allow for monitoring and maintenance of the system. The system may also incorporate various pressure gauges, transmitters, and analytical instruments to monitor and control the treatment process, ensuring proper operation and water quality.

In some aspects, the system may include a UF retentate return line (between at least one first membrane module and feed tank), which may recirculate partially treated water back through the system for further processing. This recirculation may help optimize the treatment process and improve overall system efficiency.

At the ground level, the system may have a discharge line for treated water or connection to a sewer system, providing flexibility in the management of treated effluent.

In some aspects, the membrane filtration system may utilize optional crossflow operation. Crossflow filtration involves passing the feed water parallel to the membrane surface, which can help reduce fouling and maintain higher flux rates compared to dead-end filtration. In crossflow operation, a portion of the feed water passes through the membrane as permeate, while the remainder, containing concentrated rejected materials, flows across the membrane surface and exits as retentate.

The membrane filtration system utilizing crossflow may operate at various crossflow velocities. In some implementations, the crossflow velocities may range from 0.5 to 6 m/s. Specifically, the system may operate at crossflow velocities of 0.5-1 m/s, 1-2 m/s, 2-3 m/s, 3-4 m/s, 4-5 m/s, or 5-6 m/s, depending on factors such as feed water characteristics, membrane properties, and desired performance.

In some cases, the membrane filtration system may utilize optional backwash purging to remove adhered foulants from the membrane surface and interior. Backwash purging may involve reversing the flow direction through the membrane, using water, air, oxygen, or a combination thereof. This process may help dislodge and remove accumulated particles and other foulants that can reduce membrane performance over time.

The backwash purging process may be implemented in various ways. For example, water backwashing may use treated effluent or clean water to flush the membrane in the reverse direction. Air or oxygen backwashing may involve introducing compressed air or oxygen to create turbulence and scour the membrane surface. In some implementations, a combination of water and air/oxygen backwashing may be used for more effective cleaning.

The frequency and duration of backwash purging may be adjusted based on factors such as feed water quality, membrane fouling rates, and system performance. In some cases, backwash purging may be triggered automatically based on parameters such as transmembrane pressure or permeate flux decline.

The membrane filtration system may produce permeate flux rates within a range suitable for efficient wastewater treatment. In some aspects, the system may achieve permeate flux rates of 50-1550 L/m²/h. More specifically, the membrane filtration system may produce permeate flux rates of 50-250 L/m²/h, 250-500 L/m²/h, 500-750 L/m²/h, 750-1000 L/m²/h, 1000-1250 L/m²/h, or 1250-1550 L/m²/h, depending on factors such as membrane characteristics, feed water quality, and operating conditions.

These permeate flux rates may be maintained through a combination of proper system design, optimized operating parameters, and effective fouling control measures such as crossflow operation and backwash purging. The ability to achieve and sustain these flux rates may contribute to the overall efficiency and effectiveness of the wastewater treatment system in producing high-quality effluent for non-potable reuse applications.

In some aspects, the sorption system may utilize granular activated carbon to capture dissolved organic compounds and trace contaminants. The granular activated carbon may have sieve sizes ranging from 0.045 mm to 4.75 mm. This range of sieve sizes may allow for effective removal of a wide variety of contaminants, from smaller dissolved organic compounds to larger particulates that may have passed through the membrane filtration stage.

The disinfection units utilizing electro-chlorination may contain optional custom-made electrodes for improved electro-chlorination performance. These custom electrodes may be designed to optimize the generation of chlorine-based disinfectants through the electrochemical process. In some cases, the electrode materials and configurations may be tailored to the specific water quality characteristics and disinfection requirements of the system.

The membrane filtration system with crossflow may operate at crossflow velocities of 0.5-6 m/s. This range of crossflow velocities may allow for optimization of the filtration process based on factors such as feed water characteristics, membrane properties, and desired performance. Higher crossflow velocities may help reduce membrane fouling by creating greater shear forces at the membrane surface, while lower velocities may be suitable for less challenging feed waters or when energy conservation is a priority.

In some implementations, the wastewater treatment system may utilize an optional cleaning system for advanced cleaning and foulant removal to restore performance. This cleaning system may apply various treatments, including acidic treatment, caustic treatment, bleach treatment, flushing of hot water >100° F., or a combination thereof. The specific cleaning protocol may be selected based on the type of foulants present and the membrane material characteristics.

Acidic treatment may be effective for removing inorganic scale and certain types of organic foulants. Caustic treatment may help remove organic foulants and biofilms. Bleach treatment may be used for disinfection and removal of organic contaminants. Flushing with hot water >100° F. may enhance the removal of organic foulants and improve the overall cleaning efficiency.

The water in the treated water tank may be used as a source for back washing during cleaning cycles. This approach may help optimize water use within the treatment system by reusing treated water for maintenance operations. Using treated water for backwashing may also help maintain the cleanliness of the membrane system by avoiding the introduction of new contaminants during the cleaning process.

The combination of these features—optimized sorption media, custom electrodes for disinfection, variable crossflow operation, and advanced cleaning mechanisms—may contribute to the overall efficiency, effectiveness, and longevity of the wastewater treatment system. These aspects may allow for flexible operation across a range of wastewater characteristics and treatment requirements, while maintaining high performance and minimizing maintenance needs.

### Residential Process

In some cases, the systems and methods of the present disclosure may be used for a treatment system process for residential domestic wastewater treatment and reuse.

The system may be designed to process various types of domestic wastewater influent, which may include greywater, blackwater, septic tank effluent, septage, or combinations thereof.

In some aspects, the system may comprise several components arranged in a specific order to treat the wastewater. The domestic wastewater influent may enter the system through a feed pump from pump basin. This pump may be configured to transfer wastewater from a collection tank or other source to the subsequent treatment stages.

The wastewater may then pass through a membrane module, which in some implementations may be a ceramic tubular ultrafiltration unit. The membrane module may be designed to remove suspended solids and other non-dissolved contaminants from the wastewater. In some cases, the membrane filtration system may utilize crossflow operation to enhance performance and reduce fouling.

Downstream of the membrane module, the system may include a granular activated carbon unit. This unit may be configured to capture dissolved organic compounds and trace contaminants from the filtered water. The granular activated carbon may have various sieve sizes, potentially ranging from 0.045 mm to 4.75 mm, to effectively remove a wide range of contaminants.

Following the granular activated carbon unit, the water may flow into an electro-chlorination unit. This unit may be responsible for disinfecting the treated effluent, eliminating pathogenic microorganisms. In some implementations, the electro-chlorination unit may contain custom-made electrodes for improved performance. The electro-chlorination units may serve as part of the disinfection system, which may comprise electro-chlorination, UV irradiation, ozonation, or a combination thereof to eliminate pathogenic microorganisms. In some embodiments, the electro-chlorination process may create a residual disinfection chemical such as chlorine.

An effluent tank may be positioned downstream of the electro-chlorination unit. This tank may store the treated water before it is released as non-potable reuse water or discharged. The effluent tank may be designed to maintain treated water quality and prevent recontamination.

The system may include several manual valves and a globe valve, which may allow for control of water flow throughout the system. These valves may be used to direct flow, isolate components for maintenance, or adjust system operation as needed.

A pump may also be included in the system between downstream of effluent tank and upstream of the membrane module. In some aspects, this pump may be used for backwashing. Backwashing may help maintain the performance of the membrane module by removing accumulated foulants.

The layout of the components shows a linear flow from the influent to the effluent, with each component treating the water in a specific way. This arrangement may allow for progressive improvement of water quality through filtration, adsorption, and disinfection processes. The system may be designed to be flexible and adaptable to varying wastewater compositions and qualities, potentially making it suitable for a range of applications in both residential and commercial settings.

### EXAMPLE ROUTINE

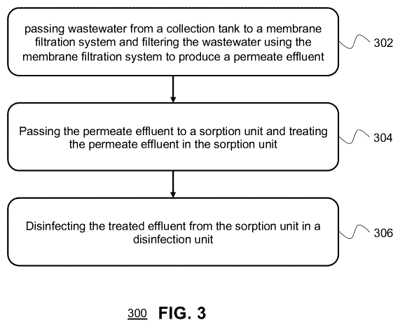

FIG. 3 depicts a flowchart illustrates a wastewater treatment process 300. The process 300 may comprise three main blocks arranged in a sequential order, representing the key stages of wastewater treatment.

The process 300 may begin with block 302, which involves passing wastewater from a collection tank to a membrane filtration system and filtering the wastewater using the membrane filtration system to produce a permeate effluent. In some aspects, the collection tank may be configured to receive and store various types of wastewater, including greywater, septic tank effluent, septage, stormwater, or combinations thereof. The membrane filtration system may utilize ceramic membranes or other suitable filtration media to remove suspended solids and other non-dissolved contaminants from the wastewater.

Following block 302, the process 300 may move to block 304. In this step, the permeate effluent may be passed to a sorption unit and treated in the sorption unit. The sorption unit may utilize granular activated carbon or other suitable sorption media to capture dissolved organic compounds and trace contaminants that may have passed through the membrane filtration stage. In some implementations, the granular activated carbon may have sieve sizes ranging from 0.045 mm to 4.75 mm, allowing for effective removal of a wide range of contaminants.

The final step in the process 300 may be block 306. This step may involve disinfecting the treated effluent from the sorption unit in a disinfection unit. The disinfection unit may employ various methods, such as electro-chlorination, UV irradiation, ozonation, or combinations thereof, to eliminate pathogenic microorganisms and ensure effluent safety. In some cases, the disinfection process may also create a residual disinfection chemical, such as chlorine, to maintain water quality during storage or distribution.

The flowchart depicts the sequence of operations in the wastewater treatment process 300, showing how the wastewater may undergo filtration, sorption, and disinfection in a specific order. Each step in the process 300 may build upon the previous one, progressively treating the wastewater through different mechanisms to produce high-quality effluent suitable for non-potable reuse applications.

In some aspects, the process 300 may include additional optional steps or variations. For example, the wastewater may be pre-filtered before passing it to the membrane filtration system in block 302. This pre-filtration step may help remove debris or large suspended solids from the feed water, potentially extending the operational life of the membrane filtration system.

The membrane filtration system in block 302 may utilize optional crossflow operation, with crossflow velocities potentially ranging from 0.5 to 6.0 m/s. Additionally, the membrane filtration system may employ backwash purging with water, air, oxygen, or combinations thereof to remove adhered foulants from the membrane surface and interior.

After the disinfection step in block 306, the treated effluent may optionally be stored in a treated water tank. This tank may be designed to maintain treated water quality and prevent recontamination, particularly when chlorine-based disinfection methods are used.

The process 300 may be controlled and automated by a control system, which may manage the operation of various components and processes throughout the wastewater treatment sequence. This automation may help ensure consistent and efficient treatment performance across varying wastewater compositions and qualities.

### Computer System

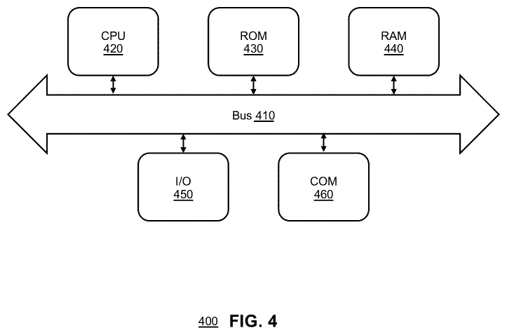

FIG. 4 depicts an example system that may execute techniques presented herein. FIG. 4 is a simplified functional block diagram of a computer that may be configured to execute techniques described herein, according to exemplary cases of the present disclosure. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### EXAMPLES

Exemplary embodiments of the systems and methods disclosed herein are described in the numbered paragraphs below.

A1. A wastewater treatment system comprising: a collection tank configured to receive and store wastewater comprising of greywater, septic tank effluent, septage, stormwater or a combination thereof; a membrane filtration system connected to and receiving wastewater from the collection tank; a sorption unit receiving permeate effluent from the membrane filtration system; and a disinfection unit downstream of the sorption unit.

A2. The system of A1, wherein the system is configured to treat septic tank effluent to a quality sufficient to enable alternative effluent discharge methods and obviate the need for a soil absorption field.

A3. The system of A1-A2, wherein the system is elevated above ground level to provide flood protection.

A4. The system of A1-A2, wherein the system is contained within an above-ground enclosure configured to facilitate relocation of the system to an alternative site.

A5. The system of any of A1-A2, wherein the membrane filtration system utilizes a ceramic membrane to remove suspended solids and other non-dissolved contaminants.

A6. The system of A1, wherein the sorption system utilizes granular activated carbon to capture dissolved organic compounds and trace contaminants.

A7. The system of A1, wherein the disinfection unit comprises electro-chlorination, UV irradiation, ozonation, or a combination thereof to eliminate pathogenic microorganisms and in some embodiments create a residual disinfection chemical such as chlorine.

A8. The system of A1, wherein a treated water tank may be optionally positioned downstream of the disinfection unit for the storage of treated water.

A9. The system of A5, wherein the ceramic membrane comprises a

microfiltration or ultrafiltration or nanofiltration membrane.

A10. The system of A5, wherein the ceramic membrane comprises a tubular membrane.

A11. The system of A1, wherein the membrane filtration system may utilize optional crossflow.

A12. The system of A1, wherein the membrane filtration system may utilize optional backwash purging with water or air or oxygen or a combination thereof to remove adhered foulants from the membrane surface and interior.

A13. The system of A1, wherein the membrane filtration system may be paired with optional pre-filters in advance of membrane filtration to remove debris or large suspended solids from feed water.

A14. The system of A1, wherein the membrane filtration system produces permeate flux rates of up to 1550 L/m²/h.

A15. The system of A1, wherein the sorption system utilizes granular activated carbon with sieve sizes ranging from 0.045 mm to 4.75 mm.

A16. The system of A1, wherein the disinfection units utilizing electro-chlorination contain optional custom-made electrodes for improved electro-chlorination performance.

A17. The system of A11, wherein the membrane filtration system with crossflow operates at crossflow velocities of 0.5-6.0 m/s.

A18. The system of any of A1-A17, wherein the wastewater treatment system can be paired with biological treatment systems to improve the effluent quality of biologically treated wastewater.

A19. The system of any of A1-A18, wherein the wastewater treatment system may utilize an optional cleaning system that applies acidic treatment, caustic treatment, bleach treatment, flushing of hot water >100° F., or a combination thereof for advanced cleaning and foulant removal to restore performance.

A20. The system of A8, wherein the treated water tank positioned downstream from the disinfection unit is designed to maintain treated water quality and prevent recontamination if used with a chlorination method such electro-chlorination.

A21. The system of A20, wherein the water in the treated water tank is used as a source for back washing during cleaning cycles.

A22. The system of any of A1-A21, wherein the wastewater treatment system can be operated at 7 kWh/day.

A23. A method for treating wastewater comprising of greywater, septic tank effluent, septage or a combination thereof, the method comprising: receiving and storing wastewater in a collection tank; passing the wastewater from the collection tank to a membrane filtration system; filtering the wastewater using the membrane filtration system to produce a permeate effluent; passing the permeate effluent to a sorption unit;

treating the permeate effluent in the sorption unit; and disinfecting the treated effluent from the sorption unit in a disinfection unit.

A24. The method of A23, wherein filtering the wastewater comprises using a ceramic membrane to remove suspended solids and other non-dissolved contaminants.

A26. The method of A23, wherein treating the permeate effluent in the sorption unit comprises using granular activated carbon to capture dissolved organic compounds and trace contaminants.

A27. The method of A23, wherein disinfecting the treated effluent comprises using electro-chlorination, UV irradiation, ozonation, or a combination thereof to eliminate pathogenic microorganisms.

A28. The method of any of A23-A27, further comprising storing the disinfected effluent in a treated water tank positioned downstream of the disinfection unit.

A29. The method of A24, wherein the ceramic membrane comprises a microfiltration, ultrafiltration, or nanofiltration membrane.

A30. The method of A24, further comprising utilizing crossflow in the membrane filtration system.

A31. The method of A24, further comprising backwash purging the membrane filtration system with water, air, oxygen, or a combination thereof to remove adhered foulants from the membrane surface and interior.

A32. The method of any of A23-A32, further comprising pre-filtering the wastewater before passing it to the membrane filtration system to remove debris or large suspended solids.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A wastewater treatment system comprising:
a collection tank configured to receive and store wastewater comprising of greywater, septic tank effluent, septage, stormwater, or a combination thereof;
a membrane filtration system connected to and receiving wastewater from the collection tank;
a sorption unit receiving permeate effluent from the membrane filtration system; and
a disinfection unit downstream of the sorption unit.

2. The system of claim 1, wherein the system is configured to treat septic tank effluent to a quality sufficient to enable alternative effluent discharge methods and obviate the need for a soil absorption field.

3. The system of claims 1, wherein the system is elevated above ground level to provide flood protection.

4. The system of claim 1, wherein the system is contained within an above-ground enclosure configured to facilitate relocation of the system to an alternative site.

5. The system of claim 1, wherein the membrane filtration system utilizes a ceramic membrane to remove suspended solids and other non-dissolved contaminants.

6. The system of claim 1, wherein the sorption system utilizes granular activated carbon to capture dissolved organic compounds and trace contaminants.

7. The system of claim 1, wherein the disinfection unit comprises electro-chlorination, UV irradiation, ozonation, or a combination thereof to eliminate pathogenic microorganisms and in some embodiments create a residual disinfection chemical such as chlorine.

8. The system of claim 1, wherein a treated water tank may be optionally positioned downstream of the disinfection unit for the storage of treated water.

9. The system of claim 1, wherein the Wastewater Treatment System can be paired with biological treatment systems to improve the effluent quality of biologically treated wastewater.

10. The system of claim 5, wherein the ceramic membrane comprises a microfiltration or ultrafiltration or nanofiltration membrane.

11. The system of claim 5, wherein the ceramic membrane comprises a tubular membrane.

12. The system of claim 1, wherein the membrane filtration system may utilize optional crossflow.

13. The system of claim 1, wherein the membrane filtration system may utilize optional backwash purging with water or air or oxygen or a combination thereof to remove adhered foulants from the membrane surface and interior.

14. The system of claim 1, wherein the membrane filtration system may be paired with optional pre-filters in advance of membrane filtration to remove debris or large suspended solids from feed water.

15. The system of claim 1, wherein the membrane filtration system produces permeate flux rates of up to 1550 L/m²/h.

16. The system of claim 9, wherein the membrane filtration system with crossflow operates at crossflow velocities of 0.5-6 m/s.

17. The system of claim 1, wherein the Wastewater Treatment System may utilize an optional cleaning system that applies acidic treatment, caustic treatment, bleach treatment, flushing of hot water >100° F., or a combination thereof for advanced cleaning and foulant removal to restore performance.

18. The system of claim 8, wherein the water in the treated water tank is used as a source for back washing the membranes.

19. The system of claim 1, wherein the Wastewater Treatment System can be operated at 7 kWh/day.

20. A method for treating wastewater comprising of greywater, septic tank effluent, septage, or combination thereof, the method comprising:
receiving and storing wastewater in a collection tank;
passing the wastewater from the collection tank to a membrane filtration system;
filtering the wastewater using the membrane filtration system to produce a permeate effluent;
passing the permeate effluent to a sorption unit;
treating the permeate effluent in the sorption unit; and
disinfecting the treated effluent from the sorption unit in a disinfection unit.
